(19) United States
(12) Patent Application Publication
(10) Pub. No.: US 2026/0311944 A1
(43) Pub. Date: Oct. 8, 2026

(54) Thermal Protector

(71) Applicant: UCHIYA THERMOSTAT CO., LTD., Saitama (JP)

(72) Inventor: Kazuyuki Iizuka, Misato-shi, Saitama (JP)

(73) Assignee: UCHIYA THERMOSTAT CO., LTD., Saitama (JP)

(21) Appl. No.: 19/483,067

(22) PCT Filed: May 10, 2024
(86) PCT No.: PCT/JP2024/017406

§ 371 Date: Nov. 11, 2025

(30) Foreign Application Priority Data
May 15, 2023 (JP) 2023-080028

(51) Int. Cl. H01H 37/52; H01H 37/04

(52) U.S. Cl. CPC H01H 37/52; H01H 37/04

(57) ABSTRACT

A self-holding type thermal protector includes a fixed plate including a fixed contact, a base member, a conductive movable plate including, at one end, a movable contact facing the fixed contact, a thermally actuated element operating in reverse when a set operating temperature is exceeded and displaces the movable plate to separate from the fixed contact, the movable contact that is in contact with the fixed contact, a heat generating resistor, an action member having an elastic material, and a fixed member. The action member includes a fixed section in surface contact with at least a part of the heat generating resistor via a fixed section of the movable plate and is fixed by the base member and the fixed member and an arm section that is adjacent to the fixed section and includes a protrusion section that comes into press contact with the center of the thermally actuated element.

### CROSS-REFERENCE TO RELATED APPLICATION

The present application is a national phase entry under 35 U.S.C. § 371 of International Application No. PCT/JP2024/017406 filed on May 10, 2024, which claims the benefit of the priority of Japanese Patent Application No. 2023-080028, filed on May 15, 2023, the disclosures of both of which are hereby incorporated by reference in their entirety.

### TECHNICAL FIELD

The present invention relates to thermal protectors that are connected to electric equipment and open and close an electric circuit with a thermally actuated element. More specifically, the present invention relates to a self-holding type thermal protector that incorporates a heat generating resistor and maintains an open state of contacts with heat generation of the heat generating resistor at the time of contact opening.

### BACKGROUND ART

As a thermal protector, there are an automatic reset type and a self-holding type.

An automatic reset type thermal protector incorporating a bimetal is sometimes used to prevent the temperature from rising to a fixed value or more in the normal use state of electric equipment, or to remain inactive in the normal use state, but activate in an abnormal state to prevent the temperature from rising to a dangerous temperature or higher. In the thermal protector of this type, the bimetal operates in reverse at a set operating temperature to open contacts to cut off an electric circuit. Thereafter, when the ambient temperature drops, the bimetal operates in reverse again at the set reset temperature, the contacts come into contact with each other, and the electric circuit is automatically reconnected.

In the case of the automatic reset type, even if the electric equipment is in an abnormal state because of a failure or the like, the electric circuit is automatically connected again only if the temperature of the electric equipment drops. When the automatic reset type thermal protector is used in motor equipment, since it is unknown when the thermal protector after operation is reset, a rotary fan, a rotary blade, and the like connected to the motor equipment are likely to suddenly start rotating at a time not intended by a user of the motor equipment.

A self-holding type thermal protector is used to prevent the automatic reconnection of the electric circuit. The self-holding type thermal protector incorporates a heat generating resistor including a PTC element. After contact opening, an open state of contacts is maintained by heat generation of the heat generating resistor as long as a user of electric equipment does not cut off a power supply.

Patent Document 1 describes a method of efficiently transferring generated heat of a heat generating resistor to a bimetal in a self-holding type thermal protector. In general, a thermal protector is required to raise a contacting pressure of a movable contact to a fixed contact for stabilization of a contact resistance value, measures against a conduction failure, prevention of opening between contacts due to vibration from the outside, and the like.

Patent Document 2 describes a thermal protector in which an external force action member for pressing a bimetal plate against a movable plate side is provided to raise a contact pressure and a large burden is not applied to reversal of the bimetal plate.

Patent Document 3 describes a structure in which a bimetal is disposed to always press a movable plate in the direction of a fixed plate with an elastic force of the bimetal at a set temperature or lower to raise a contact pressure.

Patent Document 4 describes that stress is applied to a heat deformation plate such as a bimetal with a screw or the like to raise a contact pressure.

### REFERENCE DOCUMENT LIST

### Patent Documents

Patent Document 1: JP 3756700 B

Patent Document 2: JP 2002-184276 A

Patent Document 3: JP 2844026 B

Patent Document 4: JP Sho 62-88232

### SUMMARY OF THE INVENTION

### Problem to be Solved by the Invention

Thermal protectors are roughly divided into an unfixed type in which a thermally actuated element such as a bimetal is not fixed and a fixed type in which a part of the thermally actuated element is fixed to another member. Patent Documents 1 and 2 relate to the unfixed type and Patent Documents 3 and 4 relate to the fixed type.

The unfixed type has a degree of freedom in specification setting because, in a production process, a member in which a bimetal is to be built is produced in advance and a bimetal adapted to operation specifications only has to be inserted in a post process. Since a bimetal shape is not so complicated, an operating temperature can be freely set, for example, between 10° C. and 200° C. Since the contact pressure is usually obtained from only the elastic force of the movable plate, the contact pressure is approximately 100 to 200 mN. If the elastic force of the movable plate is increased in order to increase the contact pressure, a reversing force of the bimetal is inferior and appropriate opening and closing of the contacts is difficult. Thus, the structure described in Patent Document 2 is proposed in order to obtain a high contact pressure.

On the other hand, in the fixed type, the contact pressure can be raised by the bimetal. However, since it is necessary to build the bimetal simultaneously with other components in the production process, it is difficult to later change operation specifications. Since it is necessary to provide, in the bimetal, a portion for fixing the bimetal, operating temperature setting is not easy and a temperature zone is limited (it is difficult to set a low temperature such as 10° C. and a high temperature such as 200° C.).

The self-holding type thermal protector is required to efficiently transfer the heat of the heat generating resistor to the bimetal after a reversing operation of the bimetal. However, only with heat transfer to only a part of the bimetal, deviation of a reversal shape of the bimetal increases and a reversal state is inappropriate, and it is difficult to maintain the reversal state, that is, a self-holding state of the bimetal because of disturbance of temperature.

In view of the circumstances described above, an object of the present invention is to provide a self-holding type thermal protector that is an unfixed type in which a thermally actuated element is not fixed, has a high contact pressure before a reversing operation of the thermally actuated element, and can efficiently transfer the heat of a heat generating resistor to the thermally actuated element after the reversing operation.

### Means for Solving the Problem

A thermal protector according to an aspect of the present invention includes: a conductive fixed plate including a fixed contact at one end and including a first terminal at another end; an electrically insulative base member; a conductive movable plate including, at one end, a movable contact facing the fixed contact and including, at another end, a fixed section to the base member and a second terminal; a thermally actuated element that operates in reverse when a set operating temperature is exceeded and displaces the movable plate with a reversing force of the reversing operation to separate, from the fixed contact, the movable contact that is in contact with the fixed contact; a heat generating resistor disposed between the fixed plate and the movable plate; an action member made of an elastic material; and a fixed member. The action member includes: a fixed section that comes into surface contact with at least a part of the heat generating resistor via the fixed section of the movable plate and is fixed by the base member and the fixed member; and an arm section that is adjacent to the fixed section and includes a protrusion section that comes into press contact with a center of the thermally actuated element.

### Effects of the Invention

According to the present invention, it is possible to provide a self-holding type thermal protector that is an unfixed type in which a thermally actuated element is not fixed, has a high contact pressure before a reversing operation of the thermally actuated element, and can efficiently transfer the heat of a heat generating resistor to the thermally actuated element after the reversing operation.

### BRIEF DESCRIPTION OF THE DRAWINGS

FIG. 1 is a longitudinal sectional view of a thermal protector according to a first embodiment.

FIG. 2 is an A-A line sectional view of FIG. 1.

FIG. 3 is an exploded perspective view of the thermal protector according to the first embodiment.

FIG. 4 is a B-B line sectional view of an action member illustrated in FIG. 3.

FIG. 5 is a longitudinal sectional view of the thermal protector after a bimetal has operated in reverse according to the first embodiment.

FIG. 6 is a C-C line sectional view of the action member, a fixed member, and the bimetal illustrated in FIG. 5.

FIG. 7 is a perspective view of the bimetal after having operated in reverse.

FIG. 8 is a longitudinal sectional view of a thermal protector according to a second embodiment.

FIG. 9 is a D-D line sectional view of FIG. 8.

FIG. 10 is a perspective view of an action member and a fixed member illustrated in FIG. 8.

FIG. 11 is a longitudinal sectional view of the thermal protector after a bimetal has operated in reverse according to the second embodiment.

FIG. 12 is an E-E line sectional view of the action member and the bimetal illustrated in FIG. 11.

FIG. 13 is a longitudinal sectional view of a thermal protector according to a third embodiment.

FIG. 14A is a perspective view of an action member in which slits are provided.

FIG. 14B is a perspective view of an action member in which ribs are provided.

### MODE FOR CARRYING OUT THE INVENTION

Thermal protectors according to embodiments of the present invention are described with reference to the drawings. However, the present invention is not limited by the embodiments described below. Dimension ratios of shapes illustrated in the drawings are sometimes not actual dimension ratios. The dimension ratios are sometimes changed in order to clearly describe the shapes.

### First Embodiment

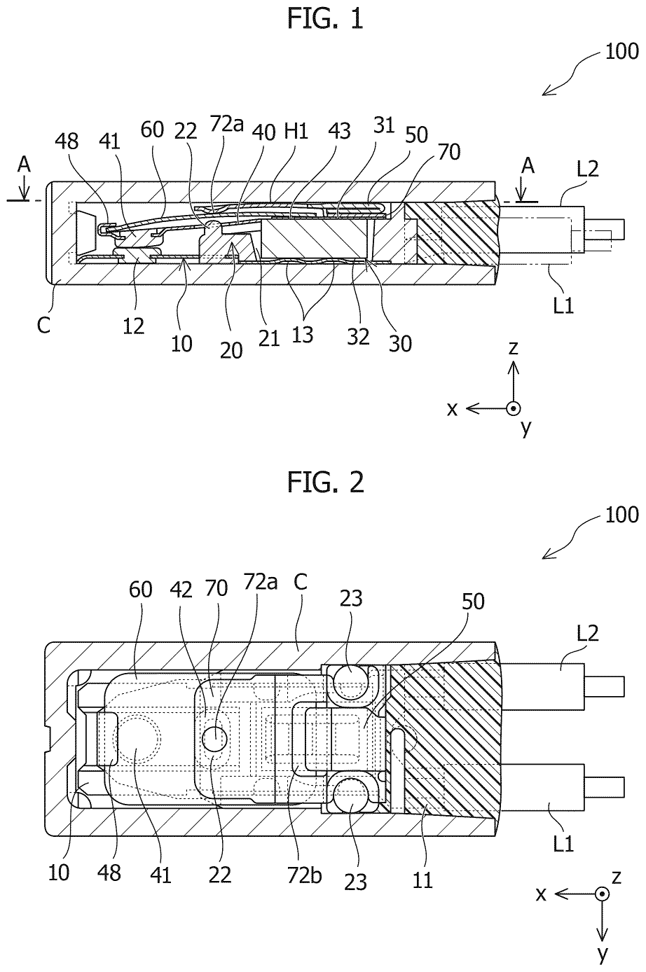

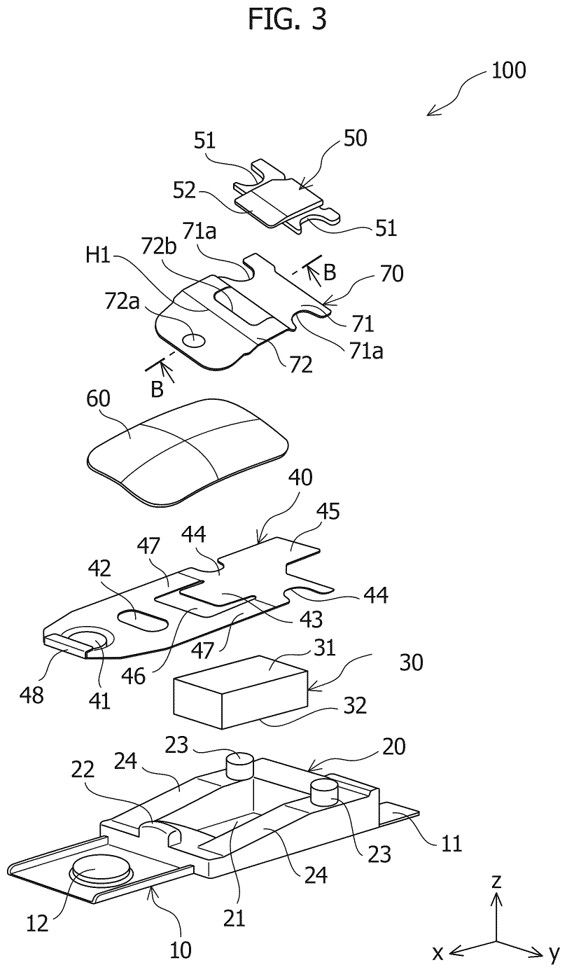

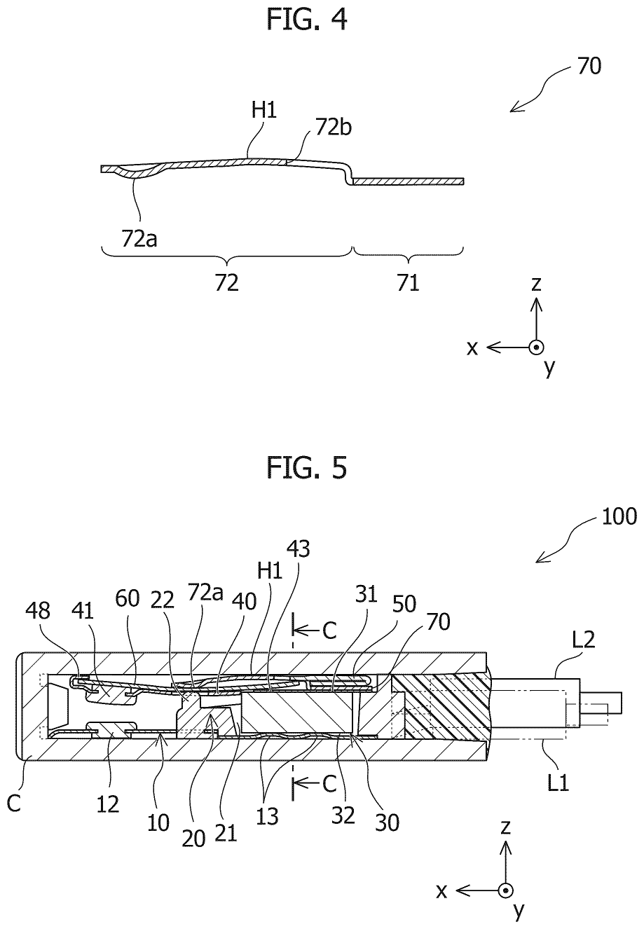

FIG. 1 is a longitudinal sectional view of a thermal protector 100 according to the present embodiment, FIG. 2 is an A-A line sectional view of FIG. 1, FIG. 3 is an exploded perspective view of the thermal protector 100, and FIG. 4 is a B-B line sectional view of an action member 70 illustrated in FIG. 3.

The thermal protector 100 is a plate-shaped body that is substantially rectangular as a whole. In the figures, an x-axis, a y-axis, and a z-axis respectively indicate a longitudinal direction, a width direction, and a thickness direction of the thermal protector 100. An x-axis positive direction is referred to as front as well and an x-axis negative direction is referred to as rear as well. A y-axis positive direction (a left side direction when facing the front of the thermal protector 100) is referred to as a left direction as well and a y-axis negative direction is referred to as a right direction as well. A z-axis positive direction (a direction from the rear surface to the front surface of the thermal protector 100) is referred to as upward as well and a z-axis negative direction is referred to as downward as well.

The thermal protector 100 includes a fixed plate 10, a base member 20, a heat generating resistor 30, a movable plate 40, a bimetal 60, the action member 70, and a fixed member 50.

The fixed plate 10 is made of a metal plate having elasticity and includes a terminal for external connection 11 at the rear end portion and includes a fixed contact 12 at the front end portion. The base member 20 formed of an electrically insulative resin material is fixed and disposed on the fixed plate 10. As illustrated in FIG. 3, the base member 20 includes a square hole 21 penetrating the center in the thickness direction. The rectangular parallelepiped heat generating resistor 30 including a PTC (positive temperature coefficient) element is housed in the square hole 21. In the base member 20, a protrusion 22 is formed in the upper surface center of the distal end portion and columns 23 are formed on both sides in the width direction of the upper surface of the rear end portion.

The movable plate 40 formed of a metal plate having elasticity is disposed above the base member 20. The movable plate 40 includes a movable contact 41 formed on a distal end portion lower surface and facing the fixed contact 12 in the thickness direction, an escape hole 42 provided in the rear of the movable contact 41, a tongue piece 43 provided in the rear of the escape hole 42, cutout sections 44 formed on both sides in the width direction of the rear end portion, and a terminal for external connection 45 formed at the rear end.

The tongue piece 43 is formed by providing a substantially U-shaped cutout 46 in the center of the movable plate 40. The tongue piece 43 extends along a longitudinal axis of the movable plate 40. The proximal end of the tongue piece 43 is located in the rear and the distal end of the tongue piece 43 is located in the front (on the movable contact 41 side).

Elongated elastic arm sections 47 extending in the longitudinal direction are formed on both sides in the width direction of the tongue piece 43. The elastic arm sections 47 are bent downward at the rear end part of the cutout 46. Therefore, a front half section of the movable plate 40 including the elastic arm sections 47 forms an acute angle with respect to the tongue piece 43. The cutout sections 44 are fit with the columns 23 of the base member 20.

The plate-shaped action member 70 having elasticity and thermal conductivity is provided in an upper part of the movable plate 40. The action member 70 is made of metal having relatively high thermal conductivity such as a copper alloy and includes a fixed section 71 fixed as described below and an arm section 72 located in the front to be adjacent to the fixed section 71. Cutout sections 71a that fit with the columns 23 of the base member 20 are formed on both sides in the width direction of the fixed section 71.

The arm section 72 includes, through bending in two parts, a standing section extending in upward from the front end portion of the fixed section 71 and a main body section extending to the front from the upper end portion of the standing section (FIG. 4). The main body section of the arm section 72 includes a bent section H1 extending in the width direction and gently rises toward the bent section H1 from the main body section rear end and gently descends toward the main body section front end from the bent section H1. A protrusion 72a recessed on the upper surface and projecting on the lower surface is provided at the distal end portion of the main body section of the arm section 72. The shape in the top view and the bottom view of the protrusion 72a is not limited to a circle illustrated in FIG. 3 and may be an ellipse (not illustrated). In the arm section 72, a hole 72b is provided from the standing section to the main body section rear end portion.

The fixed member 50 made of metal is disposed on the upper surface of the fixed section 71 of the action member 70. Cutout sections 51 formed on both sides in the width direction of the fixed member 50 are fit with the columns 23 of the base member 20. A front end portion 52 of the fixed member 50 projects to the front from the hole 72b of the action member 70.

The movable plate 40, the action member 70, and the fixed member 50 are fixed to the base member 20 by performing thermal caulking for applying pressure to upper parts of the columns 23 to crush the columns 23 while heating the columns 23 with which the cutout sections 44 of the movable plate 40, the cutout sections 71a of the action member 70, and the cutout sections 51 of the fixed member 50 are fit.

Therefore, the rear end portion of the movable plate 40 and the fixed section 71 of the action member 70 are sandwiched by the lower surface of the fixed member 50 and the rear end portion upper surface of the base member 20. The fixed section 71 of the action member 70 is in surface contact with a part of an upper surface 31 of the heat generating resistor 30 via the rear end portion of the movable plate 40. The front end portion 52 of the fixed member 50 projects to the front from the hole 72b of the action member 70 as described above. The protrusion 22 of the base member 20 projects upward from the hole 42 of the movable plate 40.

The bimetal 60, which is a rectangular plate-shaped member and is a thermally actuated body, is inserted between the movable plate 40 and the arm section 72 of the action member 70. The front end of the bimetal 60 is locked to a claw 48 provided at the distal end of the movable plate 40 and the rear end of the bimetal 60 is locked to the lower surface of the front end portion 52 of the fixed member 50 projecting to the front from the hole 72b. The insertion of the bimetal 60 may be either before or after the thermal caulking process described above. There are more degrees of freedom of specification setting when a bimetal adapted to operation specifications is inserted after the thermal caulking process. The thermal protector is the unfixed type and the bimetal 60 is not fixed to another member. The movable contact 41 is in press contact with the fixed contact 12 by the elasticity of the movable plate 40 supported by the base member 20. At this time, the protrusion 22 of the base member 20 is penetrated in the escape hole 42 and the tongue piece 43 adheres to the upper electrode surface 31 (FIG. 3) of the heat generating resistor 30.

At a normal state time (see FIG. 1) when the movable contact 41 of the movable plate 40 is in press contact with the fixed contact 12, the distal end of the movable plate 40 is located lower than the upper electrode surface 31 (FIG. 3) of the heat generating resistor 30. In this state, the arm section 47 of the movable plate 40 is located on the side of the heat generating resistor 30. Since slopes 24 to be lower toward the front are formed in the front half section as illustrated in FIG. 3, the base member 20 is prevented from coming into contact with the arm section 47.

The protrusion 72a of the arm section 72 of the action member 70 comes into contact with the center of the bimetal 60 to press the center downward and stress is applied to the distal end of the movable plate 40, whereby movable contact 41 is further pressed against the fixed contact 12. That is, by providing the action member 70, contact pressure before a bimetal reversing operation is increased. Because the center of the bimetal 60, not the peripheral edge portion, is pressed by the protrusion 72a, an operating temperature set in the bimetal 60 is not changed by the pressing of the protrusion 72a.

In the fixed plate 10, two bulging sections 13 having wavy cross sections in the axis direction view are formed at parts located below the hole 21 of the base member 20. The two bulging sections 13 are located adjacent to each other in the longitudinal direction of the fixed plate 10. Parallel slits extending in the longitudinal direction are formed on both sides in the width direction of the two bulging sections 13. The bulging sections 13 are formed by pressing a region between the two slits in a wavy shape.

The height of the lower end of a trough section formed between the two bulging sections 13 is set to be equal to or larger than the upper surface height of the flat section of the fixed plate 10. Since the bulging sections 13 have elasticity in the up-down direction, as illustrated in FIG. 1, the bulging sections 13 are elastically in contact with a lower electrode surface 32 of the heat generating resistor 30.

Since the bulging sections 13 urge the heat generating resistor 30 upward with the elasticity thereof, even when an error is present in the height dimension of the heat generating resistor 30, the error is absorbed by the elasticity of the bulging sections 13. As a result, electric contact of the tongue piece 43 and the upper electrode 31 of the heat generating resistor 30 and electric contact of the fixed plate 10 and the lower electrode 32 of the heat generating resistor 30 are stabilized.

Note that surface treatment (for example, plating) for improving electric contact stability may be applied respectively to a contact surface of the tongue piece 43 with the upper electrode surface 31 of the heat generating resistor 30 and contact surfaces of the bulging sections 13 with the lower electrode surface 32 of the heat generating resistor 30. Accordingly, it is possible to further improve the electrical contact stability of the tongue piece 43 and the fixed plate 10 with the heat generating resistor 30.

It is also possible to improve the electrical contact stability using a method other than the surface treatment. That is, conductive paste may be interposed between the upper electrode surface 31 of the heat generating resistor 30 and the tongue piece 43 and between the lower electrode surface 32 of the heat generating resistor 30 and the fixed plate 10.

A mechanical element assembled as described above is inserted into an electrically insulative resin case C, the external shape of which is a rectangular parallelepiped and in the rear end face (an end face on the x-axis negative direction side) of which an opening is formed.

The bent section H1 of the arm section 72, which is present at the highest position among the built-in members (the fixed plate 10, the base member 20, the heat generating resistor 30, the movable plate 40, the bimetal 60, the action member 70, and the fixed member 50) illustrated in FIG. 3, is present at a position higher than the height of the inner surface of the case C. For that reason, the built-in members are inserted to push the bent section H1 into the inner surface of the case C. After insertion completion, a higher contact pressure is generated. Since the insertion into the case C is performed as described above, the pressing of the bimetal 60 can be increased. On the other hand, since the pressing by the arm section 72 is relatively small before the insertion, the insertion of the bimetal 60 can be easily performed.

The opening of the case C is sealed by resin. A lead wire L1 is connected to, by welding or the like, the terminal for external connection 11 formed at the rear end of the fixed plate 10 and a lead wire L2 is connected to, by welding or the like, the terminal for external connection 45 formed at the rear end of the movable plate 40.

As an example, when various bimetals, operating temperatures of which are set to 50° C. to 170° C., are built in, contact pressures are respectively 500 to 1000 mN. It is possible to greatly increase the contact pressures compared with a general contact pressure 100 to 200 mN of a thermal protector of a bimetal unfixed type by the related art.

In general, the shape (the thickness direction dimension) of a bimetal is different depending on a set operating temperature. However, since the protrusion section 72a of the action member 70 is movable, the center of the bimetal can be pressed following the shape of the bimetal.

### Action

In the thermal protector 100, when the contacts are closed at a relatively low temperature, a load current flows in the order of the external connection terminal 11, the fixed plate 10, the fixed contact 12, the movable contact 41, the movable plate 40, and the external connection terminal 45 or in reverse order to this order.

When the temperature of the bimetal 60 rises, the bimetal 60 changes (increases) in a curvature radius and the shape of the bimetal 60 becomes close to a plane shape from a curved shape. The bimetal 60 is pressed by the protrusion 72a of the arm section 72 following the change of the bimetal 60. Since a bend of the action member 70 decreases when the shape becomes close to the plane shape, the pressing to the bimetal 60 decreases and the contact pressure also decreases. Since the stress applied to the bimetal 60 decreases, the operating temperature of the bimetal 60 does not change from a design value (an operating temperature measured in the bimetal alone before the bimetal is built in).

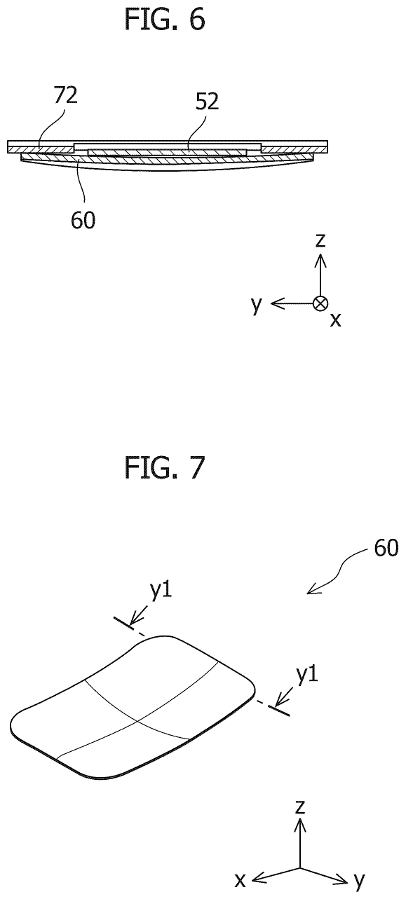

When the temperature of the bimetal 60 reaches a set operating temperature, the bimetal 60 operates in reverse with a snap action with the protrusion 22 of the base member 20 as a fulcrum. FIG. 5 is a longitudinal sectional view of the thermal protector 100 after the bimetal 60 has operated in reverse, FIG. 6 is a C-C line sectional view of the action member 90, the fixed member 50, and the bimetal 60 illustrated in FIG. 5, FIG. 7 is a perspective view of the bimetal 60 that has operated in reverse. The cross section of the bimetal 60 illustrated in FIG. 6 is equivalent to a y1-y1 line cross section of FIG. 7. The bimetal 60 curves respectively in the x-axis direction and the y-axis direction as illustrated in FIG. 7.

The movable contact 41 is separated from the fixed contact 12 by a reversing force of the bimetal 60. As a result, an electric circuit is cut off.

The protrusion section 72a of the arm section 72 is in contact with the upper surface center of the bimetal 60. The lower surface center of the bimetal 60 is in contact with the protrusion 22 of the base member 20. For this reason, the contact of the protrusion section 72 of the arm section 72 does not affect a reset temperature set in the bimetal.

As illustrated in FIG. 6, the bottom surface of the front end portion 52 of the fixed member 50 is located further on the bimetal 60 side than the bottom surface of the arm section 72 and the bimetal 60 is bent. Therefore, the front end portion 52 of the fixed member 50 and both the left and right end portions of the arm section 72 come into contact with the bimetal 60.

Incidentally, the rear end portion lower surface of the reversed bimetal 60 is in contact with the distal end portion upper surface of the tongue piece 43 of the movable plate 40. This is because, in a state in which the movable contact 41 is in press contact with the fixed contact 12, the height of the distal end of the movable plate 40 is set to be equal to or less than the height of the upper electrode surface 31 of the heat generating resistor 30.

When the movable contact 41 is separated from the fixed contact 12 by the reversing operation of the bimetal 60, a voltage is applied to the heat generating resistor 30 through the external connection terminals 11 and 45. The heat generating resistor 30 comes into an energized state and generates heat.

The heat is conducted not only from the tongue piece 43 of the movable plate 40 and the distal end of the fixed member 50 but also from both the left and right end portions and the protrusion section 72a of the arm section 72 directly to the bimetal 60. Since the fixed section 71 of the action member 70 is in surface contact with a part of the upper surface of the heat generating resistor 30 via one end of the movable plate 40, heat is efficiently conducted to the bimetal 60 (in particular, the rear end portion). Since the protrusion section 72a of the arm section 72 is in contact with the center of the bimetal 60, heat is efficiently conducted to the front end portion of the bimetal 60. For that reason, deviation is small in the reversed shape of the bimetal 60 after the reversal and the reversed shape is an appropriate reversed shape. Since the bimetal is sufficiently reversed, a gap (a contact gap) between the fixed contact 12 and the movable contact 41 increases and an electric current can be instantaneously cut off. As a result, it is possible to maintain a self-holding state more stable than in the related art.

Note that, as illustrated in FIG. 6, the bottom surface of the front end portion 52 of the fixed member 50, being located further on the bimetal 60 side than the bottom surface of the arm section 72, contributes to expansion of the contact gap as well. This is because the rear end portion of the bimetal 60 falls and the front end portion of the bimetal 60 rises with the protrusion 22 of the base member 20 as a fulcrum. In the self-holding state, the bent section H1 of the arm section 72 may be in contact with, or not be in contact with, the case inner surface. However, when the bent section H1 is not in contact with the case inner surface, since heat does not escape from the bent section H1 to the case, the bimetal 60 is more efficiently heated.

When the heat generating resistor 30 generates heat, the heat is conducted to the bimetal 60 via an internal space. Since a part of the bimetal 60 is in contact with the tongue piece 43 of the movable plate 40 adhering to the heat generating resistor 30, the heat of the heat generating resistor 30 is directly conducted to the bimetal 60 via the contact part. As a result, a reversed state of the bimetal 60 is maintained and an open state of the movable contact 41 continues. That is, the self-holding is implemented.

Note that, when a power supply switch of electric equipment (not illustrated), to which the thermal protector 100 is connected, is turned off, the energization to the heat generating resistor 30 stops and the heat generation also stops. As a result, the temperature of the bimetal 60 drops. When the temperature of the bimetal 60 drops to the set reset temperature, the bimetal 60 performs a re-reversing operation (a reset operation) and the movable contact 41 comes into contact with the fixed contact 12 again as illustrated in FIG. 1.

It is also possible to provide, on the upper surface of the tongue piece 43 of the movable plate 40, a protrusion that comes into contact with the bimetal 60 after the reversal. In that case, the positions, the shapes, and the like of the heat generating resistor 30 and the tongue piece 43 only have to be set such that the protrusion comes into contact with a part slightly further to the rear than the center of the bimetal 60.

As described above, when the protrusion is provided in the tongue piece 43, the bimetal 60 comes into contact with the protrusion. Therefore, the heat of the heat generating resistor 30 is more efficiently conducted to the bimetal 60.

However, regardless of whether the protrusion is provided in the tongue piece 43, the bimetal 60 is reversed with the protrusion 22 of the base member 20 as a fulcrum and the center of the bimetal 60 after the reversal is sandwiched by the protrusion 22 and the protrusion section 72a of the action member 70. Stress is applied to the bimetal only from the claw 48 provided at the distal end of the movable plate 40. For that reason, it is possible to prevent the reset temperature of the bimetal 60 from greatly changing from a designed value (a reset temperature measured in the bimetal alone before the bimetal is built in).

### Second Embodiment

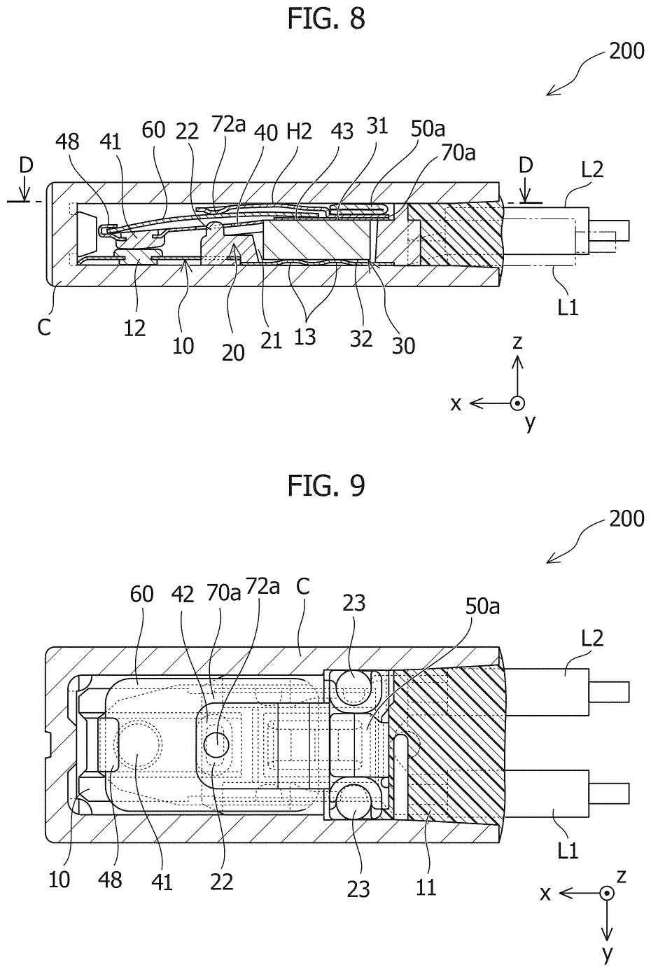

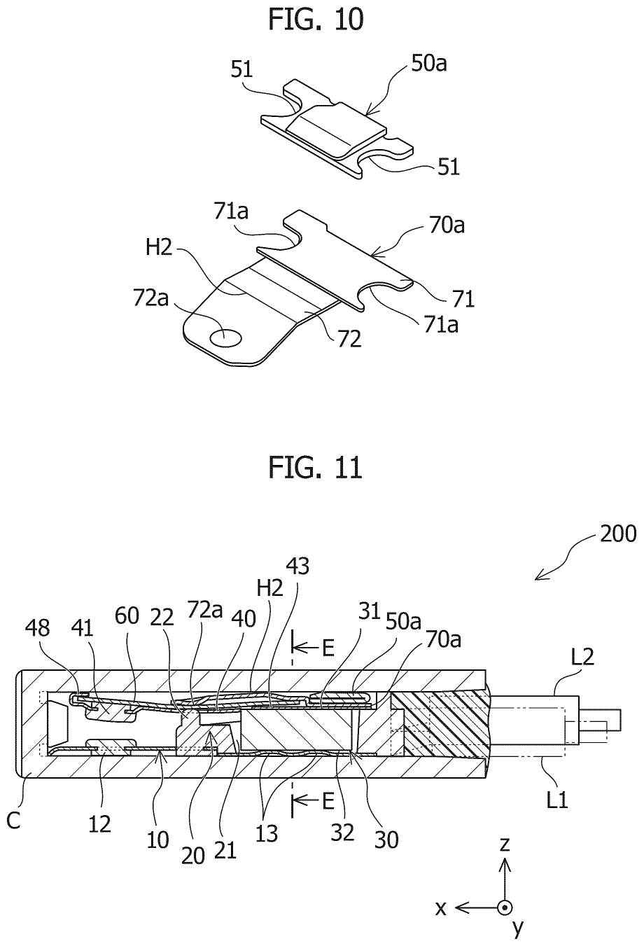

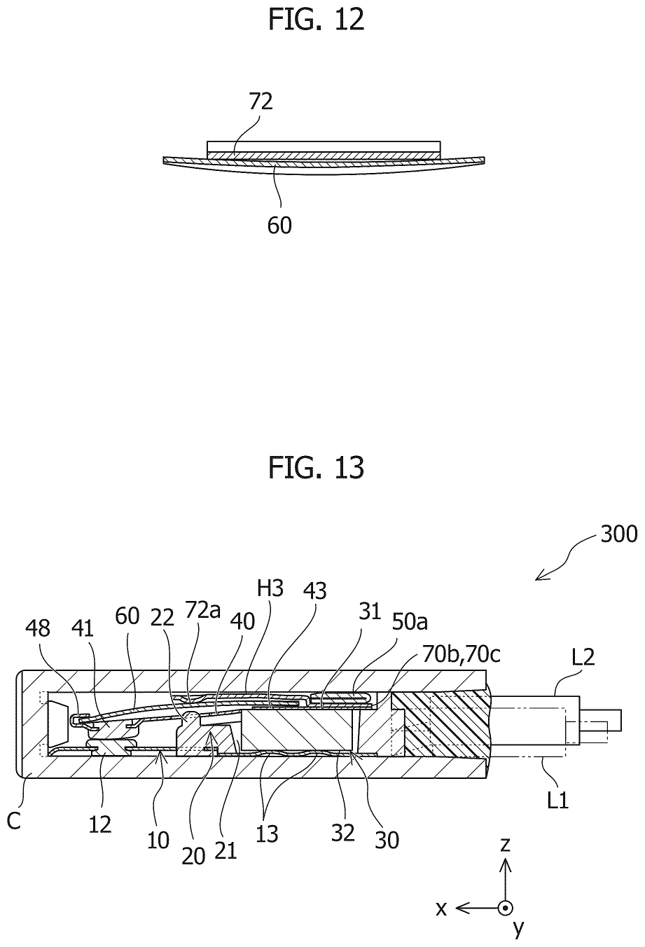

FIG. 8 is a longitudinal sectional view of a thermal protector 200 according to the present embodiment, FIG. 9 is a D-D line sectional view of FIG. 8, and FIG. 10 is a perspective view of an action member and a fixed member. FIG. 11 is a longitudinal sectional view of the thermal protector 200 in which a bimetal has operated in reverse and FIG. 12 is an E-E line sectional view of the action member and the bimetal illustrated in FIG. 11.

A configuration of the thermal protector 200 is the same as the configuration of the thermal protector 100 according to the first embodiment, except for the action member and the fixed member.

Unlike in the first embodiment, an action member 70a does not include the hole section 72b. A fixed section 50a does not include the front end portion 52 projecting to the front through the hole section 72 in the first embodiment.

In order to suppress an elastic force increase of the arm section 72 of the action member 70a due to the absence of the hole section 72b, the width direction dimension of the arm section 72 may be set smaller than the width direction dimension in the first embodiment.

The action member 70a includes a bent section H2 equivalent to the bent section H1 of the action member 70.

As in the first embodiment, the bent section H2 of the arm section 72 of the action member 70a comes into contact with the inner surface of the electrically insulative resin case C, the protrusion section 72a of the arm section 72 comes into contact with the center of the bimetal 60 to press the bimetal 60, and stress is applied to the distal end portion of the movable plate 40, whereby contact pressure increases.

Since the hole section 72 is not provided in the arm section 72 of the action member 70a as described above, the heat of a heat generating resistor after contact opening is more efficiently conducted to the bimetal. Since the end portion of the bimetal comes into contact with an arm as illustrated in FIG. 12 and the center of the bimetal comes into contact with a protrusion section of the arm, generated heat is conducted to the other end portion of the bimetal and a reversed shape of the bimetal becomes an appropriate reversed shape in which deviation is small. Since the bimetal is sufficiently reversed, a contact gap increases and an electric current can be instantaneously cut off. As a result, it is possible to maintain a self-holding state that is more stable than in the related art.

### Third Embodiment

In FIG. 13, a longitudinal sectional view of a thermal protector according to an embodiment is illustrated. A configuration of the thermal protector is the same as the configuration in the second embodiment, except that a bent section H3 of the arm section 72 of an action member 70b does not come into contact with the inner surface of the electrically insulative resin case C.

In the first embodiment and the second embodiment, the bent section of the arm is brought into contact with the inner surface of the case C to increase the contact pressure. In the present embodiment, the rigidity of the action member is adjusted by adjusting the material, the thickness, the width, a bending position, a bending angle, and the like of the action member 70b, and the contact pressure is increased without a part of an arm of the action member 70b being brought into the inner surface of the case.

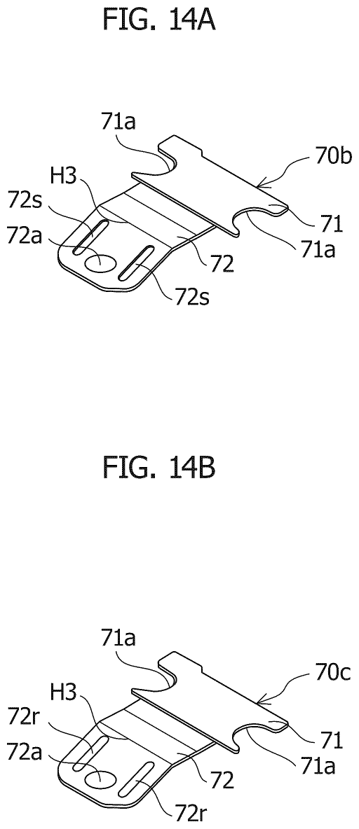

The rigidity of the arm can be reduced by providing, in the action member 70b, two slits 72s extending in the longitudinal direction as illustrated in FIG. 14A Alternatively, the rigidity of the arm can be increased by providing convex sections 72r of an action member 70c as illustrated in FIG. 14B,

In both cases, by preventing the bent section H3 of the arm from coming into contact with the inner surface of the case even after contact opening, the heat of a heat generating resistor does not escape from the bent section H3 to the case C and the heat of the heat generating resistor can be efficiently conducted to the bimetal. Since the bimetal is sufficiently reversed, a contact gap increases and an electric current can be instantaneously cut off. As a result, it is possible to maintain a self-holding state that is more stable than in the related art.

As described above, according to the embodiments, it is possible to provide a self-holding type thermal protector that is an unfixed type having a degree of freedom of specification setting in a production process, has a higher contact pressure before a reversing operation than in the related art, and can efficiently transfer the heat of a heat generating resistor to a bimetal after the reversing operation.

The following supplements are disclosed concerning the embodiments described above.

### Supplement 1

A thermal protector including:
a conductive fixed plate including a fixed contact at one end and including a first terminal at another end;
an electrically insulative base member;
a conductive movable plate including, at one end, a movable contact facing the fixed contact and including, at another end, a fixed section to the base member and a second terminal;
a thermally actuated element that operates in reverse when a set operating temperature is exceeded and displaces the movable plate with a reversing force of the reversing operation to separate, from the fixed contact, the movable contact that is in contact with the fixed contact;
a heat generating resistor disposed between the fixed plate and the movable plate;
an action member made of an elastic material; and
a fixed member, wherein
the action member includes:
   a fixed section that comes into surface contact with at least a part of the heat generating resistor via the fixed section of the movable plate and is fixed by the base member and the fixed member; and
   an arm section that is adjacent to the fixed section and includes a protrusion section that comes into press contact with a center of the thermally actuated element.

### Supplement 2

The thermal protector described in the Supplement 1, wherein, while reversal of the thermally activated element is maintained by heat generated by the thermally activated element operating in reverse and a voltage being applied to the heat generating resistor,
the arm section comes into contact with a peripheral edge portion of the thermally activated element, and
the protruding section comes into press contact with the center of the thermally activated element.

### Supplement 3

The thermal protector described in the Supplement 1, wherein, when the thermally activated element is at a low temperature or is in a temperature raising process before the reversing operation, a part of the arm section comes into contact with a housing inner surface of the thermal protector.

### Supplement 4

The thermal protector described in the Supplement 2, wherein
a hole section is formed in the arm section, and a front end portion of the fixed member projects through the hole section, and
a bottom surface of the front end portion is located further on the thermally activated element side than a lower surface of a periphery of the hole section in the arm section, and the front end portion comes into contact with the thermally activated element.

The embodiments of the present invention are described above. However, the present invention is not limited to the embodiments described above, and various modifications and changes can be made based on the technical concept of the present invention.

### REFERENCE SYMBOL LIST

100, 200, 300 Thermal protector
10 Fixed plate
11 External connection terminal
12 Fixed contact
20 Base member
21 Hole
22 Protrusion
23 Column
30 Heat generating resistor
40 Movable plate
41 Movable contact
43 Tongue piece
45 External connection terminal
46 Cutout
50 Fixed member
60 Bimetal
70 Action member

1. A thermal protector comprising:
a conductive fixed plate including a fixed contact at one end and including a first terminal at another end;
an electrically insulative base member;
a conductive movable plate including, at one end, a movable contact facing the fixed contact and including, at another end, a fixed section to the base member and a second terminal;
a thermally actuated element that operates in reverse when a set operating temperature is exceeded and displaces the movable plate with a reversing force of a reversing operation to separate, from the fixed contact, the movable contact that is in contact with the fixed contact;
a heat generating resistor disposed between the fixed plate and the movable plate;
an action member made of an elastic material; and
a fixed member, wherein
the action member includes:
a fixed section that comes into surface contact with at least a part of the heat generating resistor via the fixed section of the movable plate and is fixed by the base member and the fixed member; and
an arm section that is adjacent to the fixed section and includes a protrusion section that comes into press contact with a center of the thermally actuated element.

2. The thermal protector according to claim 1, wherein, while reversal of the thermally actuated element is maintained by heat generated by the thermally actuated element operating in reverse and a voltage being applied to the heat generating resistor,
the arm section comes into contact with a peripheral edge portion of the thermally actuated element, and
the protrusion section comes into press contact with the center of the thermally actuated element.

3. The thermal protector according to claim 1, wherein, when the thermally actuated element is at a low temperature or is in a temperature raising process before the reversing operation, a part of the arm section comes into contact with a housing inner surface of the thermal protector.

4. The thermal protector according to claim 2, wherein
a hole section is formed in the arm section, and a front end portion of the fixed member projects through the hole section, and
a bottom surface of the front end portion is located further on the thermally actuated element side than a lower surface of a periphery of the hole section in the arm section, and the front end portion comes into contact with the thermally actuated element.
